(19) United States
(12) Patent Application Publication
(10) Pub. No.: US 2007/0075107 A1
(43) Pub. Date: Apr. 5, 2007

(54) Set comprising a base and a console which is slideable and extractable in relation to the base and correspondng motor vehicle

(76) Inventors: Christian Brancheriau, Herblay (FR); David Duchez, Andelu (FR)

Correspondence Address: YOUNG & THOMPSON, 745 SOUTH 23RD STREET, 2ND FLOOR, ARLINGTON, VA, 22202, US

(21) Appl. No.: 10/548,097

(22) PCT Filed: Mar. 4, 2005
(86) PCT No.: PCT/FR04/00514

§ 371 Date: Oct. 23, 2006

(30) Foreign Application Priority Data
Mar. 5, 2003 (FR) 03 02723

(51) Int. Cl. B60R 7/00; B60R 11/00

(52) U.S. Cl. 224/281; 224/554; 224/929

(57) ABSTRACT

The set (1) for a motor vehicle comprises a base (2), a console (3) which is slideable in relation to the base along a direction of sliding, and means for linking the console to the base, said connecting means comprising at least one locking element (46) which can move between a locking position, wherein the console is locked in relation to the base along the direction of sliding and the locking element retains the console (3) in relation to the base (2), thereby preventing extraction, and a sliding position wherein the console (3) can slide in relation to the base along the direction of sliding. The connecting means enable the console to be released from the base for extraction from the motor vehicle. The base also comprises an extraction area (16) wherein a gap (20) is provided and the locking element (46), when in a locked position, can move through the gap (20) in order to extract the console from the motor vehicle.

The present invention relates to an assembly for a motor vehicle of the type comprising a base, a console which is slidingly movable relative to the base in a sliding direction and means for connecting the console to the base, the connection means comprising at least a locking element which is movable between a locking position, in which the console is locked relative to the base in the sliding direction and the locking element retains the console relative to the base to prevent removal, and a sliding position, in which the console can slide relative to the base in the sliding direction. The connection means further allowing the console to be released from the base in order to remove it from the motor vehicle.

The invention is applied in particular to a central console assembly which is provided between right-hand and left-hand seats of a motor vehicle.

FR-2 762 811 describes an assembly of the above-mentioned type. The base comprises a slide which is fixedly joined to the floor of the vehicle. The connection means comprise two hooks which form locking elements. In the locking position, the hooks are engaged in recesses which are distributed along the edges of the slide. In the sliding position, they are retracted and disengaged from the recesses.

The connection means also comprise articulated connecting rods in order to displace the hooks between their locking positions and sliding positions. The connecting rods further allow the hooks to be displaced towards third positions, in which the hooks are retracted far enough to allow them to pass through a central aperture of the slide.

In this manner, the console can be removed from the motor vehicle, which allows the internal configuration to be constructed in modular form and, for example, space to be made available inside the passenger compartment.

However, the means for connecting the console to the base described in that document require the provision in the console of a particularly complex and costly mechanism having connecting rods in order to displace the locking elements.

An object of the invention is to solve that problem by providing an assembly of the above-mentioned type, whose console can slide and be locked along the base and be released from the base in order to remove it from the motor vehicle, but which is simpler and less expensive.

To this end, the invention relates to an assembly of the above-mentioned type, characterised in that the base comprises a removal region in which a hole is provided, and in that the element for locking in the locking position can pass through the hole in order to remove the console from the motor vehicle.

According to specific embodiments, the assembly may comprise one or more of the following features, taken in isolation or in accordance with all technically possible combinations:

the base comprises means for guiding the console relative to the base,

the guiding means comprise roller means,

the locking element is a hook which, in the locking position, is engaged under an edge of the base in order to retain the console to prevent removal, and in that the hole is provided in the edge of the base,

the base comprises a stop for controlling access of the console to the removal region,

the control stop is movable between an extracted position which prevents the console from sliding towards the removal region and a retracted position which allows the console to slide towards the removal region,

the console comprises a member which is movable between a position in which it abuts the stop in order to prevent the console from sliding towards the removal region, and a position in which it travels past the stop in order to allow the console to slide towards the removal region,

the console comprises means for displacing the connection means, and

the removal region is a travel limit region of the console relative to the base.

The invention further relates to a motor vehicle, characterised in that it comprises an assembly as defined above.

The invention will be better understood from the following description, which is given purely by way of example with reference to the appended drawings, in which:

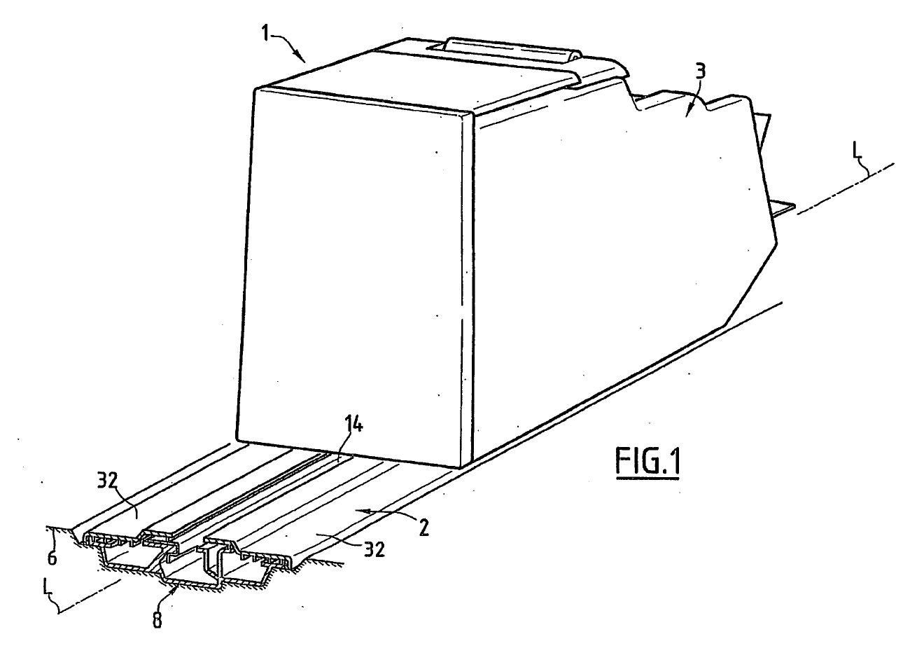

FIG. 1 is a schematic perspective view of part of the passenger compartment of a motor vehicle in accordance with the invention,

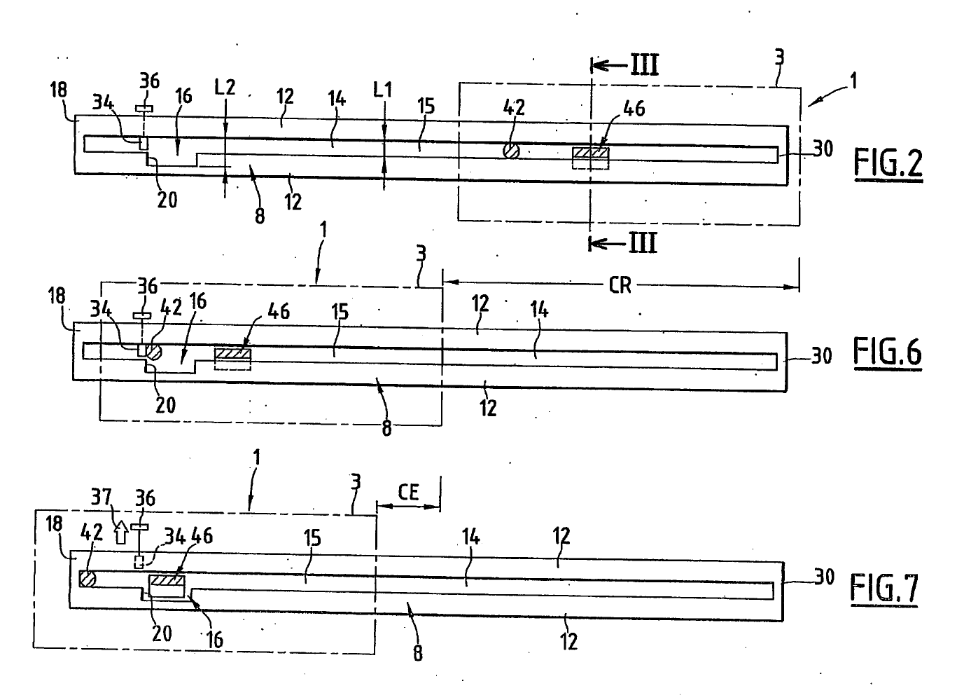

FIG. 2 is a schematic top view of the console/base assembly of the vehicle of FIG. 1,

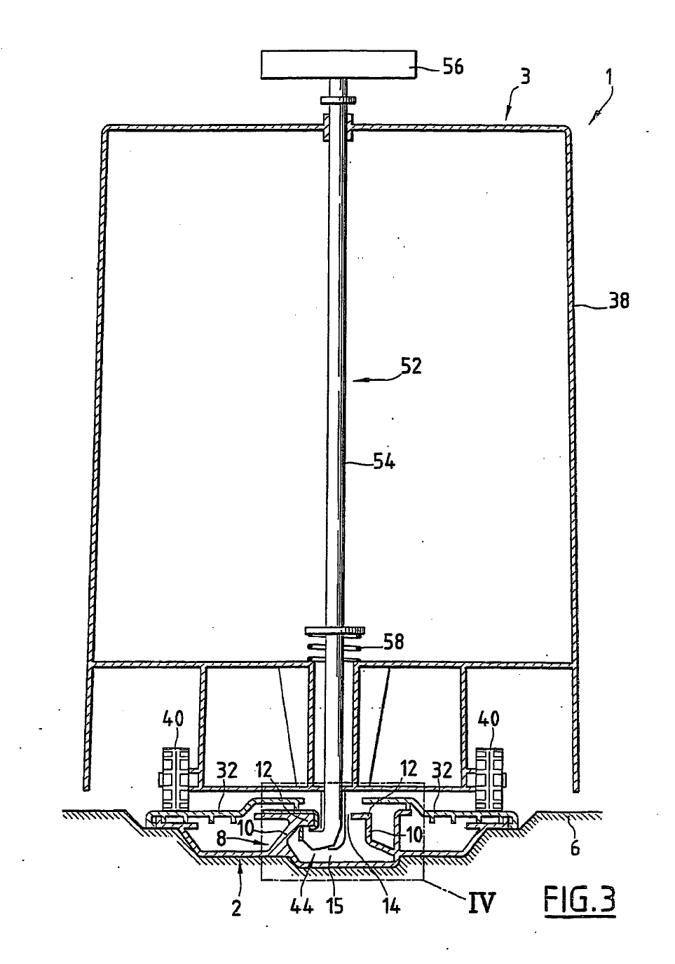

FIG. 3 is a schematic sectional view taken along line III-III of FIG. 2,

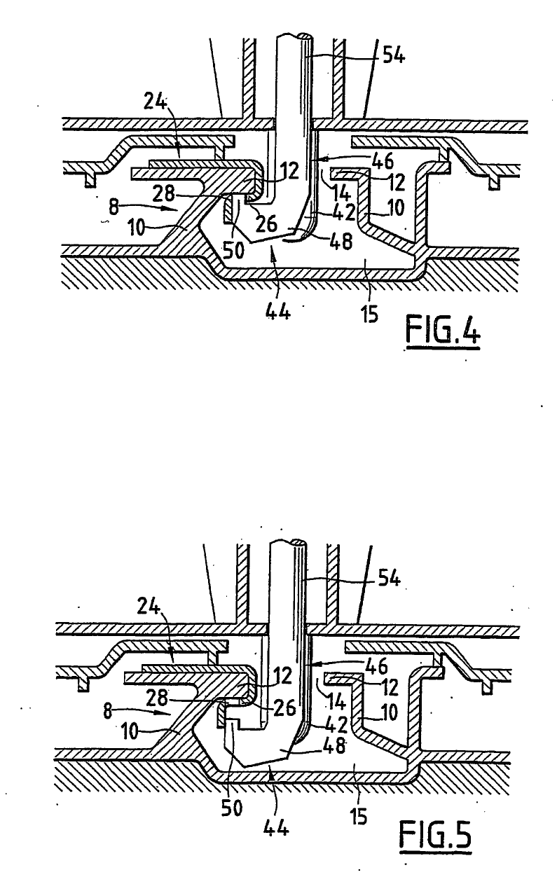

FIG. 4 is a schematic view, drawn to an enlarged scale, of the part IV of FIG. 3, illustrating the element for locking the console in the locking position,

FIG. 5 is a view similar to FIG. 4, illustrating the element for locking in the sliding position,

FIGS. 6 and 7 are views similar to FIG. 2, illustrating the removal of the console, and

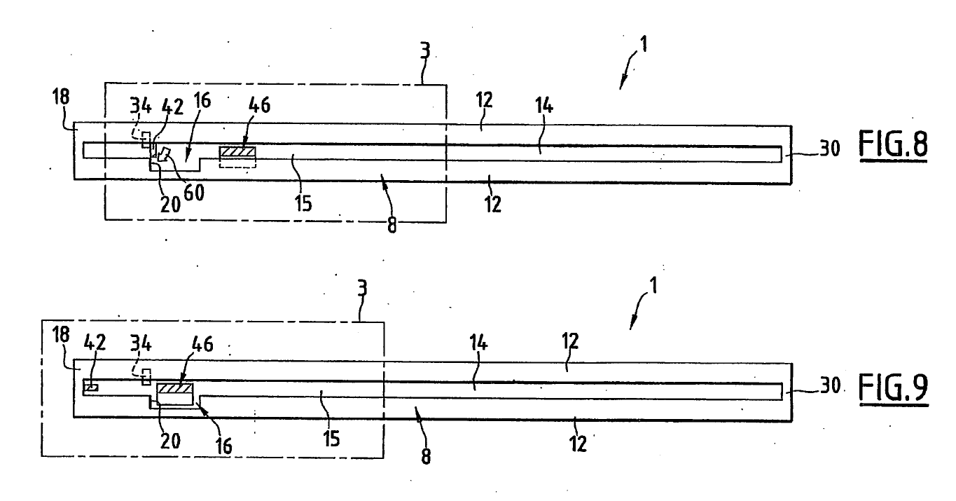

FIGS. 8 and 9 are views similar to FIGS. 6 and 7, illustrating a variant of the invention.

Hereinafter, the orientations used are the conventional orientations of a motor vehicle. In particular, the terms “front”, “rear”, “right” and “left” are intended to refer to the position of a driver and the direction of movement of the motor vehicle.

FIG. 1 schematically illustrates the passenger compartment of a motor vehicle. It shows an assembly 1 comprising a base 2 and a console 3 which is slidingly movable relative to the base 2 in a sliding direction L.

The assembly 1 is arranged between the left and right front seats (not illustrated) of the motor vehicle and the sliding direction L is substantially aligned with the longitudinal direction of the motor vehicle.

As illustrated in FIGS. 2 and 3, the base 2 is fixedly joined to the floor 6 of the motor vehicle and comprises a slide 8 which is composed, for example, of an aluminium profile-section and which extends longitudinally. The console 3 has been illustrated with dot-dash lines in FIG. 2.

The slide 8 comprises two lateral flanks 10 whose edges 12 arranged opposite each other together delimit a central aperture 14 which extends over the entire length of the slide 8. The lateral flanks 10 together delimit a longitudinal passage 15 which opens upwards via the aperture 14 in the passenger compartment.

The central aperture 14 has a substantially constant width L1, except for in a removal region 16 near the rear end 18 thereof.

In the removal region 16, the aperture 14 is widened by a removal hole 20 which is provided in the right edge 12. In this manner, the aperture 14 locally has a width L2 greater than L1.

The right edge 12 (on the left in FIGS. 3 and 4) is surrounded by a folded metal plate 24, the portion 26 of which arranged in the passage 15 under the right edge 12 has recesses 28 which are regularly distributed over the length of the metal plate 24. That metal plate 24 extends from the removal region 16 towards the front end 30 of the slide 8 in order to allow adjustment of the longitudinal position of the console 3 along an adjustment path CR (FIG. 6), as will be described below.

The base 2 further comprises two trims 32 (FIG. 3) which are arranged at one side and the other of the aperture 14 and which cover the slide 8.

Behind the removal region 16, the base 2 comprises a stop 34 which is arranged in the passage 15 and which is movable under the action of a pull member 36 between an extracted position illustrated in FIG. 2, in which the stop 34 is advanced laterally to the right under the aperture 14, and a retracted position illustrated in FIG. 7, in which the stop 34 has moved back to the left and no longer extends under the aperture 14.

The displacement of the stop 34 between the extracted position and the retracted position thereof is brought about, in the example illustrated, by drawing the pull member 36 to the left, as indicated by the arrow 37. A return member, such as a spring, may, for example, return the stop 34 to the extracted position thereof.

As illustrated in FIG. 3, the console 3 conventionally comprises a body 38 which provides a plurality of housings and compartments for receiving objects. The console 3 also comprises, for example, rollers 40 which are provided under the body 38 in order to move on the base 2. In the example illustrated in FIG. 3, the console 3 comprises four rollers 40, two of which are intended to move on the right-hand trim 32 and the other two of which are intended to move on the left-hand trim 32.

In other variants which are not illustrated, the rollers 40 may be replaced by sliding runners.

The guiding of the sliding of the console 3 relative to the base 2 is brought about, in addition to the action of the rollers 40, by a member 42 which projects downwards from the lower wall of the body 38. That member 42, which is visible in FIG. 4, extends downwards through the aperture 14 into the passage 15.

Owing to the rollers 30 and the member 42, the console 3 is guided along the slide 8 during the sliding action thereof and is retained laterally relative thereto.

The console 3 further comprises means 44 for connecting the console 3 to the base 2.

As illustrated by FIGS. 3 and 4, those connection means 44 comprise a locking element in the form of a hook 46 which is provided under the body 38 of the console 3. The hook 46 extends downwards through the aperture 14 and comprises, in the passage 15, a turned-back portion 48 which terminates in a claw 50 which is directed upwards. The hook 46 is arranged in front of the guiding member 42. The hook 46 is narrower than L2 but wider than L1 and is shorter than the hole 20.

The hook 46 is movable between:

a first raised position (FIG. 4), in which the claw 50 is engaged in a recess 28 of the metal plate 24, and

a second lowered position (FIG. 5), in which the claw 50 is disengaged from all of the recesses 28.

The vertical translation movement of the hook 46 between its two positions is brought about by displacement means 52. In the example illustrated, those displacement means 52 comprise a rod 54 which extends through the body 38. The rod 54 is extended at the lower end thereof by the hook 46. The upper end of the rod 54 is connected to a handle 56 which is provided above the body 38. In order to displace the hook 46 towards the lowered position thereof, the handle 56 is pushed downwards. A spring 58 returns the rod 54 upwards. In this manner, it is simply necessary for the handle 56 not to be acted upon for the hook 46 to return towards the raised position thereof.

In other variants, the displacement means 52 may have different structures and comprise a mechanism having connecting rods, bars, cams, cables or levers, for example, actuated by a handle carried by the upper face of the console 3.

The mechanism may also be a mechanism as described in documents EP 925 996 or the patent application filed on 7 Sep. 2001 under No. FR-01/11599.

Since the hook 46 only has to be displaced vertically between two positions, the mechanism of those last two documents can be considerably simplified. In still another variant, it is possible to use electrical displacement means 52.

When the hook 46 is in its raised position (FIG. 4), it longitudinally locks the console 3 relative to the base 2 owing to the claw 50 being engaged in a recess 28. If it is desirable to longitudinally displace the console 3, the displacement of the hook 46 is actuated towards the lowered position thereof (FIG. 5).

Since the claw 50 is disengaged from the recesses 28, the console 3 can slide relative to the base 2 between a front adjustment travel limit position, illustrated in FIG. 2, and a return position illustrated in FIG. 6.

In that return position, the member 42 is in abutment against the stop 34. The console 3 cannot therefore return beyond that position.

When the console 3 occupies a desired position along the adjustment path CR, the hook 46 is brought towards its raised locking position and the claw 50 engages in the recess 28 provided at that location. The console 3 is then locked longitudinally in the desired position relative to the base 2.

The connection means 44 therefore allow sliding and longitudinal locking of the console 3 to be brought about. Furthermore, the hook 46 which is engaged under the right edge 12 acts counter to vertical displacement of the console 3 relative to the base 2 and thus prevents the console 3 from being removed when it is located in the adjustment path CR. That applies both when the hook 46 is in the locking position and in the sliding position.

In order to remove the console 3, the stop 34 is moved into its retracted position which affords access to the rear end 18 of the slide 8. The console 3 can then slide along a removal path CE (FIG. 7) until the member 42 comes into abutment against the rear end 18 of the slide 8.

The console 3 is then in the position illustrated in FIG. 7 which is a removal travel limit position CE.

In that position, the claw 50 of the hook 46 is arranged under the hole 20. The dimensions of the hole 20 are such that it does not prevent the passage of the hook 46 whether it is in the raised locking position or in the lowered sliding position.

In the position of FIG. 7, therefore, it is simply necessary to raise the console 3 in order to be able to remove it from the motor vehicle, the hook 46 passing through the hole 20.

Therefore, the connection means 44 also allow the console 3 to be released with respect to the base 2 and to be removed from the motor vehicle.

In any case, the displacement means 52 provided in the console 3 can have a very simple and economical structure because they have to bring about the displacement of the hook 46 only between two positions without having to bring about displacement to a third position allowing the console 3 to be removed, as in the prior art.

Since the console 3 can be removed only after controlled access to a removal region 16 located outside the adjustment path CR of the console 3, the risks of accidental removal of the console 3 are lessened.

More generally, control of access to the removal region 16 may be brought about by means of a fixed stop 34 and a movable member 42, for example, by rotation or translation. Such a variant is illustrated in FIGS. 8 and 9.

In that variant, the member 42 is caused to rotate through a quarter of a turn in order to be able to pass the stop 34, as indicated by the arrow 60 in FIG. 8. In that case, the displacement of the member 42 can be actuated by a very simple mechanism, separate from the means 52 for displacing the hook 46. The mechanism can advantageously be a simple operating handle which is arranged at the bottom of a housing of the console 3 and which is directly engaged with the member 42. In that manner, even in this variant, the displacement means provided in the console 3 still have simple and economical structures.

In another variant, the slide 8 may be replaced with a rail whose two lateral edges 12 each have recesses 28 for longitudinally locking the console 3. In that case, the console 3 comprises two lateral hooks 46 which are engaged under the lateral edges of the rail. Holes which allow the hooks 46 to pass are provided in the lateral edges of the rail in order to allow the removal thereof in accordance with the principles described above.

It should also be noted that the longitudinal locking of the console 3 relative to the base 2 may be brought about by the claw 50 engaging in a single recess 28, but also by a plurality of projections of the claw 50 engaging in a plurality of successive recesses 28.

1. Assembly (1) for a motor vehicle of the type comprising a base (2), a console (3) which is slidingly movable relative to the base in a sliding direction (L), and means (44) for connecting the console to the base, the connection means comprising at least a locking element (46) which is movable between a locking position (FIG. 4), in which the console is locked relative to the base in the sliding direction and the locking element retains the console (3) relative to the base (2) to prevent removal, and a sliding position (FIG. 5), in which the console (3) can slide relative to the base in the sliding direction, the connection means (44) further allowing the console to be released from the base in order to remove it from the motor vehicle, characterised in that the base comprises a removal region (16), in which a hole (20) is provided, and in that the locking element (46) in the locking position can pass through the hole (20) in order to remove the console from the motor vehicle.

2. Assembly according to claim 1, characterised in that the base (2) comprises means (40, 42) for guiding the console (3) relative to the base (2).

3. Assembly according to claim 2, characterised in that the guiding means comprise roller means (40).

4. Assembly according to claim 2, characterised in that the locking element is a hook (46) which, in the locking position, is engaged under an edge (12) of the base (2) in order to retain the console (3) to prevent removal, and in that the hole (20) is provided in the edge (12) of the base (2).

5. Assembly according to claim 1, characterised in that the base (2) comprises a stop (34) for controlling access of the console (3) to the removal region (16).

6. Assembly according to claim 5, characterised in that the control stop (34) is movable between an extracted position (FIG. 2) which prevents the console from sliding towards the removal region (16) and a retracted position (FIG. 7) which allows the console (3) to slide towards the removal region (16).

7. Assembly according to claim 5, characterised in that the console (3) comprises a member (42) which is movable between a position (FIG. 8) in which it abuts the stop (34) in order to prevent the console from sliding towards the removal region (16), and a position (FIG. 9) in which it travels past the stop (34) in order to allow the console (3) to slide towards the removal region (16).

8. Assembly according to claim 1, characterised in that the console (3) comprises means (52) for displacing the connection means (44).

9. Assembly according to any one of the preceding claims, characterised in that the removal region (16) is a travel limit region of the console (3) relative to the base (2).

10. Motor vehicle, characterised in that it comprises an assembly according to claim 1.
